(19) United States
(12) Patent Application Publication
(10) Pub. No.: US 2025/0046181 A1
(43) Pub. Date: Feb. 6, 2025

(54) INTERSECTION BLOCKING PREVENTION

(71) Applicant: VALEO SCHALTER UND SENSOREN GMBH, Bietigheim-Bissingen (DE)

(72) Inventors: Jeff Destrumelle, Ibaraki (JP); Jean-Charles Bernard, Ibaraki (JP)

(73) Assignee: VALEO SCHALTER UND SENSOREN GMBH, Bietigheim-Bissingen (DE)

(21) Appl. No.: 18/708,985

(22) PCT Filed: Oct. 27, 2022
(86) PCT No.: PCT/EP2022/080069

§ 371 Date: May 9, 2024

(30) Foreign Application Priority Data
Nov. 10, 2021 (DE) 10 2021 129 236.0

(51) Int. Cl. G08G 1/01

(52) U.S. Cl. CPC G08G 1/01

(57) ABSTRACT

A method for performing an intersection blocking prevention for traffic participants in the vicinity of the intersection is disclosed. The method includes defining a non-blocking area for the intersection, receiving environment sensor information covering at least one exiting area and at least one entrance area adjacent to the non-blocking area and connected to the intersection. The method also includes determining a free space in the at least one exiting area as a space between the non-blocking area and the traffic participant located in the respective exiting area closest to the non-blocking area, identifying a traffic participant in the at least one entrance area with a driving path to the at least one exiting area, determining if the traffic participant fits in the free space, and sending a warning message to the traffic participant if they do not fit in the free space.

The present invention refers to a method for performing an intersection blocking prevention for traffic participants in vicinity of the intersection.

The present invention also refers to an intersection blocking prevention unit for preventing blocking the intersection with traffic participants in vicinity of the intersection, wherein the intersection blocking prevention unit is adapted to perform the above method.

Furthermore, the present invention refers to an intersection blocking prevention system for preventing blocking the intersection with traffic participants in vicinity of the intersection, comprising the above intersection blocking prevention unit and multiple traffic participants in communication connection with the intersection blocking prevention unit.

Currently, vehicles driving on a road or street can face situations where an intersection is blocked by other vehicles. When the intersection is blocked, a major problem consists in the fact that not only the vehicles on the respective driving lanes cannot advance, but also cross-traffic cannot cross the intersection, even when the driving lanes for the cross-traffic are not blocked behind the intersection. Hence, blocking of intersections leads to overall traffic fluidity issues and reduces a number of vehicles that can cross the intersection, in particular for cross-traffic. Due to traffic jams at intersections, vehicles lose a lot of time.

Blocked intersections are also considered as safety risks, since emergency vehicles like police, ambulance, fire brigade, and traffic assistance are also blocked when they have to cross the blocked intersection. Furthermore, blocking an intersection is not allowed according to many national traffic regulations.

This problem of blocking intersections becomes more and more frequent since the overall traffic is increasing in most parts of the world.

Even when drivers of the vehicles or autonomously driven vehicles try not to block intersections, this is sometimes not possible, since a field of view of a driver and/or an environment sensor of the vehicle can be blocked by another vehicle, further traffic participants, infrastructure components or others. Such a blocking of the field of view is typically most relevant in a driving direction ahead of the vehicle. However, even when the visibility of the driver of the environment sensors is not blocked, sometimes the driver or an autonomous driving system may fail in correctly calculating an available free space behind the crossing, so that the respective vehicle may move into the intersection and block the intersection.

In this context, document CN 111 768 640 A refers to an adaptive monitoring system for traffic intersections, which includes a graphics acquisition module composed of multiple groups of camera groups, wherein the upper side of each entrance and exit of the intersection is equipped with a camera group, and the installed camera group is used to collect peripheral image information. The system further includes a vehicle sensor installed on a traffic marking on the road surface to detect vehicles touching the traffic marking. A control unit receives the data information of the graphics acquisition module and the vehicle sensor. The control unit obtains the congestion index of vehicles queued at different intersections through the received picture information and completes the comparison of different congestion indices. The control unit connects the signal light controller to control the working time of the signal light according to the traffic data detected by the graphics acquisition module.

Furthermore, document JP 5 604 963 B2 refers to signal control apparatus for controlling a signal-light unit, which is installed at the crossing with a plurality of inflow channels. A first traffic amount calculating means calculates a first traffic volume of one or more lanes containing at least a straight direction. A second traffic amount calculating means calculates a second traffic of one or more lanes containing at least linear direction opposite to the first inflow channel. Inhibiting traffic amount calculating means calculate an inhibitory traffic volume, which is the difference between the first traffic volume and the second traffic volume. When the first traffic is bigger than the second traffic, the inhibition traffic volume based on whether a predetermined condition is satisfied, and for the first inflow channel to give a passage.

It is an object of the present invention to provide a method for performing an intersection blocking prevention for traffic participants in vicinity of the intersection as well as an intersection blocking prevention unit for performing the above method and an intersection blocking prevention system comprising the above intersection blocking prevention unit and multiple traffic participants in communication connection with the intersection blocking prevention unit, which enable a more fluent overall traffic flow, in particular at intersections.

This object is achieved by the independent claims. Advantageous embodiments are given in the dependent claims.

In particular, the present invention provides a method for performing an intersection blocking prevention for traffic participants in vicinity of the intersection, comprising the steps of defining a non-blocking area for the intersection, receiving environment sensor information covering at least one exiting area and at least one entrance area adjacent to the non-blocking area and connected to the intersection, determining a free space in the at least one exiting area as a space between the non-blocking area and a traffic participant located in the respective exiting area closest to the non-blocking area, identifying a traffic participant in the at least one entrance area with a driving path to the at least one exiting area, determining if the identified traffic participant fits the free space in the at least one exiting area according to its driving path, and sending a warning message to the identified traffic participant in case it does not fit in the free space in the at least one exiting area according to its driving path.

The present invention also provides an intersection blocking prevention unit for preventing blocking the intersection with traffic participants in vicinity of the intersection, wherein the intersection blocking prevention unit is adapted to perform the above method.

The present invention further provides an intersection blocking prevention system for preventing blocking the intersection with traffic participants in vicinity of the intersection, comprising the above intersection blocking prevention unit and multiple traffic participants in communication connection with the intersection blocking prevention unit.

The basic idea of the invention is to prevent blocking of an intersection based on an a priori check, whether a traffic participant, which is about to enter the intersection, in particular the non-blocking area, will be able to leave the non-blocking area based on an available space in the exiting area. Hence, when the traffic participant cannot enter the exiting area, i.e. the exiting area is crowded by other traffic participants, it a respective warning message is sent to this traffic participant, so that it can refrain from entering the non-blocking area. The blocking prevention is independent from the individual traffic participants. The warning messages can be generated in the intersection blocking prevention unit, which is provided locally for the respective intersection. This does not require a local installation of the Intersection blocking prevention unit. It merely requires local interaction with the traffic participants.

The traffic participant can be any kind of traffic participant including pedestrians, bikes, scooters, motor bikes, cars, lorries, trucks, trams, trains, or even boats and ships. Hence, the intersection can be an intersection of walkways, biking ways, streets, roads, canals, rails, or others.

The method can be applied to a single kind of traffic participants only, e.g. to trains or cars. However, when different kinds of traffic participants share a traffic way, like a road, the method can be applied to all of the involved traffic participants. Some kinds of traffic participants are constituted by vehicles, which may comprise different kinds of sensors for monitoring the environment, a user interface for generating an output to a human, and communication means for sending environment sensor information and/or for receiving intersection blocking warning messages. However, other kinds of traffic participants like pedestrians do not have such an installation of sensors, user interface and communication means. However, for example mobile phones or other mobile communication devices of these traffic participants can enables at least some functionality, e.g. a user interface for receiving intersection blocking warning messages and/or a camera for monitoring the environment.

The intersection can have any suitable format. It can be an intersection of two streets or only a junction of any number of streets or roads, e.g. like a Y-junction. The driving path specifies—beginning from the entrance area—at which exiting area the traffic participant will leave the intersection and continue its way.

The intersection comprises a central area, which is the non-blocking area, where the traffic participants shall not stop. The exiting area and the entrance area are provided adjacent to the non-blocking area. Each connection of the intersection has an exiting area for a driving direction away from the non-blocking area and an entrance area for a driving direction towards the non-blocking area. Hence, each connection will typically have an exiting area and an entrance area except for one-way streets.

The environment sensor information refers to information regarding objects including traffic participants at the intersection, i.e. objects in the exiting area and in the entrance area. The environment sensor information typically also covers the non-blocking area, although this information is not necessarily required. The environment sensor information can be sensor information from any kind of environment sensor including optical cameras, LiDAR-based environment sensors, radar sensors, ultrasonic sensors, and others. The environment sensor information can refer to processed or unprocessed sensor data. In some cases, the environment sensor information is processed prior to being received to reduce an amount of data to be transmitted. In some cases, the environment sensor information merely includes information in respect to other traffic participants.

The free space is a space of the exiting area, which is not occupied by other traffic participants, and which can potentially receive one or more further traffic participants depending on their size. However, when the free space is to small, it cannot receive any further traffic participant without the further traffic participant remaining at least partially in the non-blocking area. The free space depends on further traffic participants located in the exiting area and refers to the space between the non-blocking area and a traffic participant located in the respective exiting area closest to the non-blocking area. The free space is in general independent from driving lanes and merely specifies a space for receiving further traffic participants regardless of particular driving lanes contributing to the free space.

Identifying a traffic participant in the at least one entrance area with a driving path to the at least one exiting area refers to an identification of a possible traffic participant entering and passing through the non-blocking area towards the at least one exiting area along the driving path. Hence, this traffic participant can potentially block the intersection in case it does not fit in the free space.

The identified traffic participant fits the free space in the respective exiting area if it can enter the exiting area and does not block the intersection, i.e. the traffic participant does not remain in the non-blocking area.

The steps of determining the free space, identifying the traffic participant in the at least one entrance area with a driving path to the at least one exiting area, and determining if the identified traffic participant fits the free space in the at least one exiting area according to its driving path can be performed at least partially based on the received environment sensor information. However, such environment sensor information is not required for each of the respective steps.

Sending a warning message to the identified traffic participant in case it does not fit in the free space in the at least one exiting area according to its driving path refers to sending any kind of message, which indicates that the non-blocking area will be blocked in case the respective traffic participant advances into the non-blocking area. The warning message can generate a warning via a user interface e.g. to human passengers and/or it can be processed by an autonomous driving system of the respective traffic participant.

The same principles apply e.g. to an exit of a fire brigade with a non-blocking area. In this case, it is not required to have an intersection, and the non-blocking area can be defined as an area along a street to enable exit of the fire brigade vehicles from the fire station.

According to a modified embodiment of the invention, receiving environment sensor information covering at least one exiting area and at least one entrance area adjacent to the non-blocking area and connected to the intersection comprises receiving environment sensor information from at least one environment sensor of at least one traffic participant, and/or receiving environment sensor information from at least one environment sensor installed at the intersection. The method can be performed based on any suitable environment sensor information covering the at least one exiting area and the at least one entrance area. In case no environment sensor is installed at the intersection, the method can be performed completely without such environment sensors as long as at least one traffic participant provides environment sensor information based on its environment sensors. The other way round, in case the traffic participants in the vicinity of the intersection are not equipped with environment sensors or they cannot provide environment sensor information from their environment sensors to the intersection blocking prevention unit, the method can be performed completely without such environment sensors as long as at least one environment sensor is installed at the intersection, which covers the at least one exiting area and the at least one entrance area.

According to a modified embodiment of the invention, receiving environment sensor information comprises receiving environment sensor information from multiple environment sensors and the method comprises an additional step of performing fusion of the environment sensor information received from the multiple environment sensors. Environment sensor information from any environment sensor can be used to obtain a reliable understanding of a traffic situation at the intersection. The more environment sensors provide their environment sensor information, the more reliable can be performed the method. The fusion of the environment sensor information can be performed independently from the kind of environment sensor information and the kind of environment sensor. Hence, environment sensor information from optical cameras, LIDAR-based environment sensors, radar sensors, ultrasonic sensors, and others can be processed commonly. For example, a 2D-maplike representation of the vicinity of the intersection can be provided based on the fusion.

According to a modified embodiment of the invention, identifying a traffic participant in the at least one entrance area with a driving path to the at least one exiting area comprises identifying the traffic participant in the at least one entrance area and its driving path to the at least one exiting area based on the received environment sensor information, and/or identifying the traffic participant in the at least one entrance area and its driving path to the at least one exiting area based on a message received from the respective traffic participant identifying itself, its position, and its driving path. Hence, identification can be performed based on an observation of the traffic participants using the at least one environment sensor and/or based on information provided from the traffic participant itself. Hence, when the traffic participant sends a message indicating its position and driving path to the intersection blocking prevention unit, this can be sufficient. However, most reliable is a combination of the identification of the traffic participant in the at least one entrance area and its driving path to the at least one exiting area based on the received environment sensor information and the message received from the respective traffic participant identifying itself, its position, and its driving path. The message can include further information like dimensions of the traffic participant or others, which can be used for further method steps.

According to a modified embodiment of the invention, determining if the identified traffic participant fits the free space in the at least one exiting area according to its driving path comprises determining if the identified traffic participant fits the free space in the at least one exiting area according to its driving path based on the received environment sensor information, and/or determining if the identified traffic participant fits the free space in the at least one exiting area according to its driving path based on a message received from the respective traffic participant specifying its size. Similar to the above described identification of the traffic participant, also the step of determining if the identified traffic participant fits the free space in the at least one exiting area according to its driving path can be performed based on an observation of the traffic participants using the at least one environment sensor and/or based on information provided from the respective traffic participant itself, and a size of the respective traffic participant can be determined based on the received environment sensor information. Hence, when the traffic participant sends a message indicating its size to the intersection blocking prevention unit, this can be sufficient to determine if the identified traffic participant fits the free space. However, most reliable is a combination of the usage of the received environment sensor information and the message received from the respective traffic participant specifying its size. The message can include further information, which can be used later on when performing the method.

According to a modified embodiment of the invention, determining if the identified traffic participant fits the free space in the at least one exiting area according to its driving path comprises determining a size of the identified traffic participant and a minimum distance between two traffic participants and comparing the size of the identified traffic participant and the minimum distance between two traffic participants to the free space. Since the traffic participants shall not have physical contact with each other, a minimum distance between traffic participants has to be kept. The minimum distance can be a fix, preset value based on a required safety distance between the traffic participants. The traffic participant fits the free space if the free space is bigger than the size of the identified traffic participant together with a space defined by the minimum distance between two traffic participants. The size of the identified traffic participant can be determined based on the received environment sensor information and/or based on a message sent from the respective traffic participant to the intersection blocking prevention unit indicating its size. Furthermore, also each traffic participant can communicate its preferred value for the minimum distance to the intersection blocking prevention unit, which determines the minimum distance based on the received values for the minimum distance for each pair of adjacent traffic participants.

According to a modified embodiment of the invention, determining a minimum distance between two traffic participants comprises monitoring distances between adjacent traffic participants in the vicinity of the intersection and determining the minimum distance as average distance between the adjacent traffic participants in the vicinity of the intersection. Hence, the minimum distance can be determined based on an observation of the behavior of the different traffic participants in the vicinity of the intersection. The average distance can be observed using the at least one environment sensor. However, the average distance can also be determined based on known positions of the traffic participants and their dimensions, which can be transmitted from the traffic participants themselves to the intersection blocking prevention unit. Based on the observation of the average distance between the adjacent traffic participants in the vicinity of the intersection, the minimum distance can be chosen in a most appropriate way for each intersection. The minimum distance can be different for different intersections.

According to a modified embodiment of the invention, sending a warning message to the identified traffic participant in case it does not fit in the free space in the at least one exiting area according to its driving path comprises sending a warning message for partial intersection blocking in case the identified traffic participant partially fits in the free space in the at least one exiting area according to its driving path, a warning message for full intersection blocking in case the identified traffic participant does not at all fit in the free space in the at least one exiting area according to its driving path, and/or a priority vehicle blocking warning message to the identified traffic participant and/or to the priority vehicle in case at least one traffic participant at least partially blocks the non-blocking area. The partial intersection blocking can result in

According to a modified embodiment of the invention, the method comprises an additional step of receiving traffic participant data from at least one of the traffic participants, and the step of identifying a traffic participant in the at least one entrance area with a driving path to the at least one exiting area comprises identifying the traffic participant under consideration of the received traffic participant data. The traffic participant data refers to data different to environment sensor information. The traffic participant data is data related to the respective traffic participant sending the respective data, i.e. data like a position, velocity, driving direction, odometry information, size or an identification of the respective traffic participant as well as status information like emergency conditions or malfunctions, just to name a few.

According to a modified embodiment of the invention, the method comprises an additional step of receiving infrastructure data from the infrastructure, in particular a traffic light, and the step of identifying a traffic participant in the at least one entrance area with a driving path to the at least one exiting area comprises identifying the traffic participant under consideration of the received infrastructure data. Infrastructure data can help to identify a blocking situation. In particular, a traffic light controls a traffic flow and can interrupt the traffic flow with a red light. This can be relevant also in respect to identifying a traffic participant in the at least one entrance area with a driving path to the at least one exiting area. In case the driving path of a traffic participant to the at least one exiting area is interrupted due to a red traffic light, the traffic participant cannot reach the respective exiting area. The same applies in respect to other infrastructure components for controlling a flow of the traffic, e.g. indicating prohibited exiting areas, or indicating an obligation to continue in a certain direction.

According to a modified embodiment of the invention, the method comprises additional steps of determining if the intersection is blocked and sending a warning message to the traffic participants. When the intersection is blocked, no further traffic participants shall enter the intersection, in particular the non-blocking area. Hence, a respective warning message is sent at least to those traffic participants, which are about to enter the non-blocking area. This refers e.g. to traffic participants, which are closest to the non-blocking area in the respective at least one entrance area. The step of determining if the intersection is blocked can be performed based on the received environment sensor information and/or based on the received traffic participant data from at least one of the traffic participants and/or based on the received infrastructure data. For example, the received environment sensor information can indicate that one or more traffic participant(s) is/are in standstill in the non-blocking area. Furthermore, at least one of the traffic participants can send a message containing traffic participant data to the intersection blocking prevention unit indicating its position in the non-blocking area and its velocity being zero. Still further, also the infrastructure data can indicate that at least one traffic participant is located in the non-blocking area in standstill.

Feature and advantages described above with reference to the inventive method apply equally to the inventive driving support system and vice versa. Furthermore, the method steps described above are described merely by way of example in the order given above. The method can also be performed based on a different sequence of the respective method steps.

These and other aspects of the invention will be apparent from and elucidated with reference to the embodiments described hereinafter. Individual features disclosed in the embodiments can constitute alone or in combination an aspect of the present invention. Features of the different embodiments can be carried over from one embodiment to another embodiment.

In the drawings:

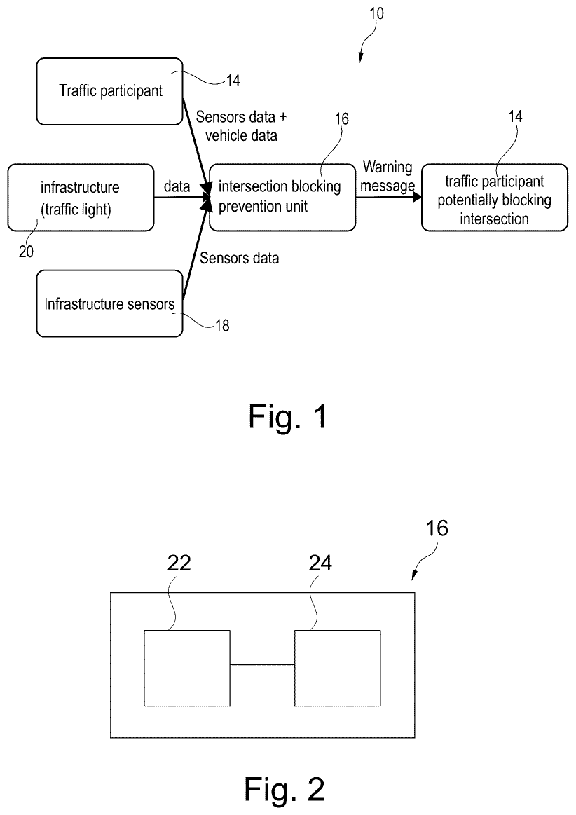

FIG. 1 shows an intersection blocking prevention system according to a first, preferred embodiment comprising an intersection blocking prevention unit, traffic participants, and further infrastructure devices and environment sensors together with an information flow,

FIG. 2 shows a schematic view of the intersection blocking prevention unit of FIG. 1 for preventing blocking the intersection with traffic participants in vicinity of the intersection comprising a communication unit and a processing unit in accordance with the first embodiment,

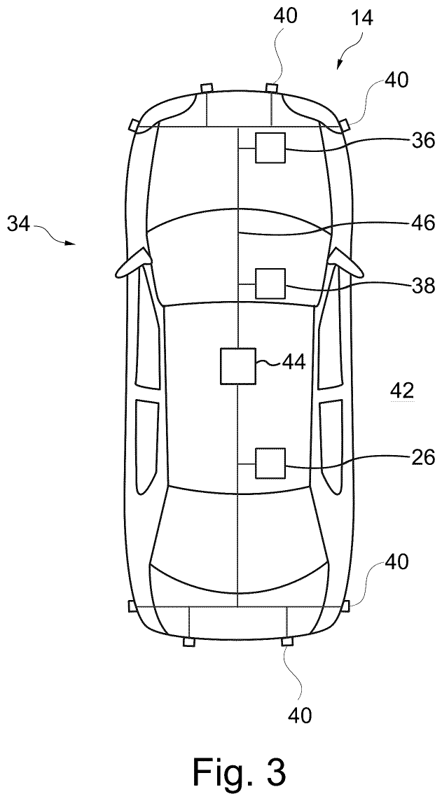

FIG. 3 shows a schematic view of an ego vehicle as traffic participant comprising a driving support system with multiple environment sensors in accordance with the first embodiment,

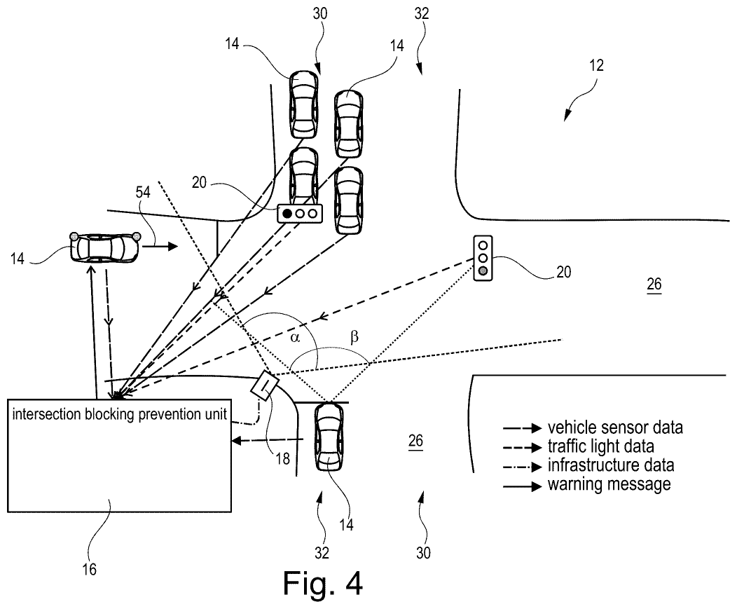

FIG. 4 shows an intersection with the intersection blocking prevention system of FIG. 1 with a first traffic situation in a left-hand traffic example,

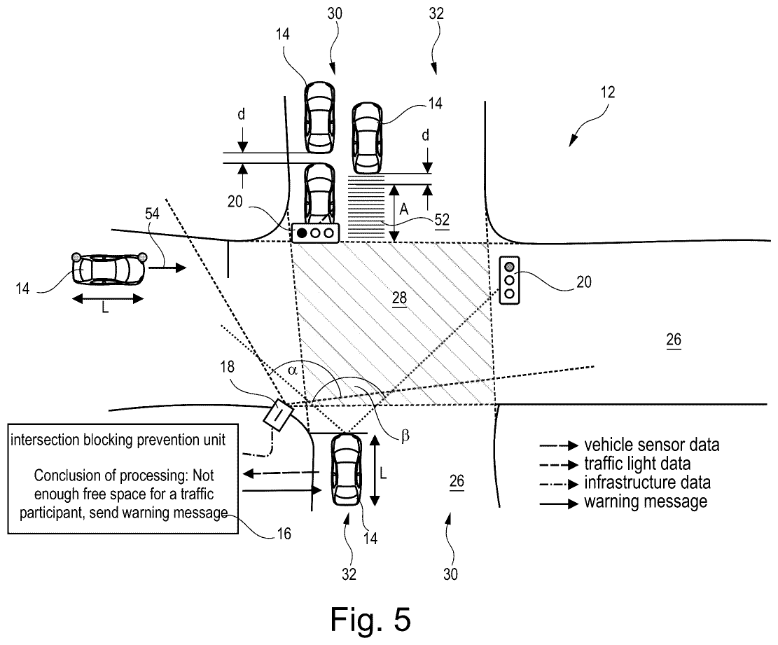

FIG. 5 shows the intersection of FIG. 4 with the intersection blocking prevention system of FIG. 1 with a second traffic situation in a left-hand traffic example,

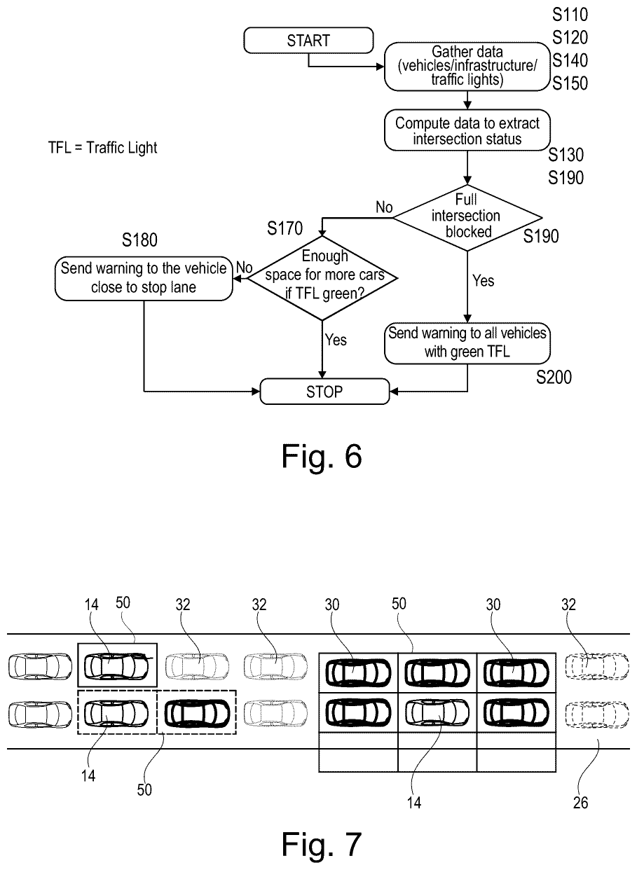

FIG. 6 shows a flow chart for performing intersection blocking prevention in accordance with the intersection blocking prevention system of FIG. 1 according to a second embodiment,

FIG. 7 shows a road with multiple traffic participants, some of which comprise different kinds of environment sensors and a communication unit, and some of which not being able to transmit environment sensor information to the intersection blocking prevention unit of FIG. 2,

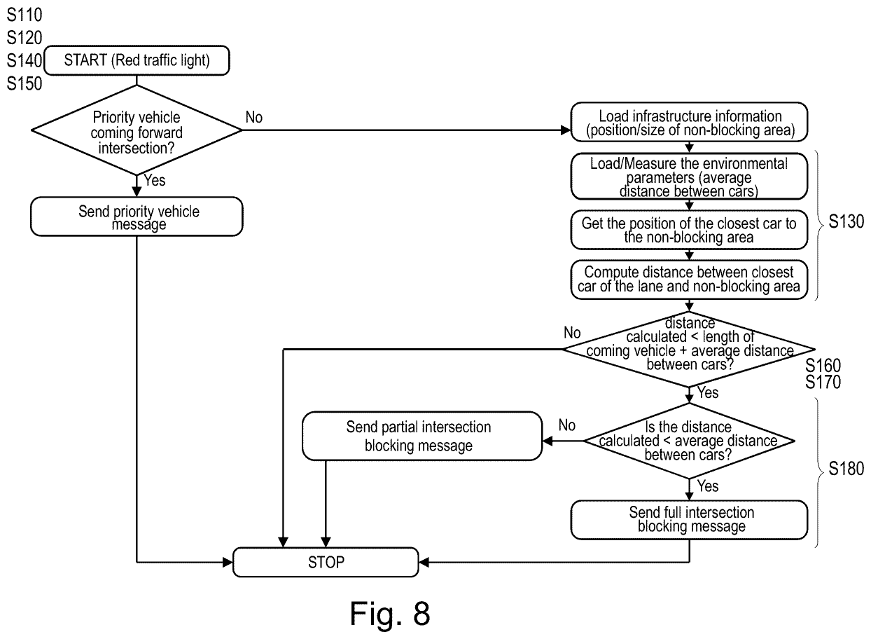

FIG. 8 shows a flow chart for performing intersection blocking prevention in accordance with the intersection blocking prevention system of FIG. 1 according to a third embodiment, and

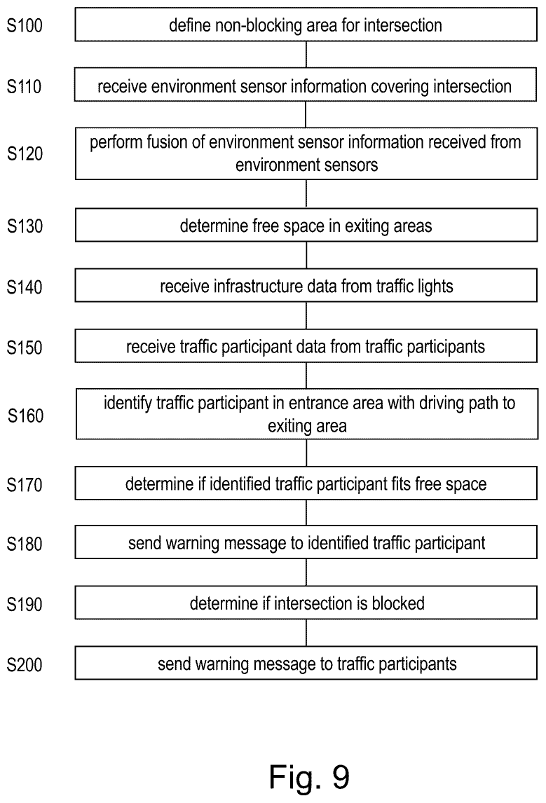

FIG. 9 shows a flow chart of a method for performing an intersection blocking prevention for traffic participants in vicinity of the intersection performed with the intersection blocking prevention system of the first embodiment and according to the first embodiment.

FIG. 1 shows an intersection blocking prevention system 10 for preventing blocking an intersection 12 with traffic participants 14 in vicinity of the intersection 12 according to a first, preferred embodiment.

The intersection blocking prevention system 10 is formed by an intersection blocking prevention unit 16 and multiple of the traffic participants 14 in communication connection with the intersection blocking prevention unit 16. Hence, the intersection blocking prevention system 10 will be modified depending on the traffic participants 14 approaching the intersection 12 and leaving the intersection 12.

As can be further seen in FIG. 1, the intersection blocking prevention system 10 additionally comprises an infrastructure environment sensor 18 for monitoring the intersection 12 and a traffic light 20. The infrastructure environment sensor 18 is an optical camera in this embodiment.

The intersection blocking prevention unit 16 can be seen in detail in FIG. 2. The intersection blocking prevention unit 16 comprises a communication unit 22 for communication with the traffic participants 14, with the infrastructure environment sensor 18 and with the traffic light 20. The intersection blocking prevention unit 16 further comprises a processing unit 24, which is connected to the communication unit 22 and processes information received via the communication unit 22.

The traffic participants 14 can be any kind of traffic participants 14 including pedestrians, bikes, scooters, motor bikes, cars, lorries, trucks, trams, trains, or even boats and ships. Hence, the intersection 12 can be an intersection 12 of walkways, biking ways, streets, roads, canals, rails, or others.

In this embodiment, the intersection 12 is an intersection 12 of two streets 26, as can be seen by way of example in FIGS. 4 and 5. The intersection 12 comprises a central non-blocking area 28, where the traffic participants 14 shall not stop. The non-blocking area 28 is marked e.g. in FIG. 5. The intersection 12 further comprises exiting areas 30 and entrance areas 32 provided adjacent to the non-blocking area 28. Each connection of the intersection 12 has one exiting area 30 for a driving direction away from the non-blocking area 28 and one entrance area 32 for a driving direction towards the non-blocking area 28.

One possible traffic participant 14 is shown in FIG. 3. The traffic participant 14 is a vehicle comprising a driving support system 34, which provides a particular form of driving support. The traffic participant 14 can be any kind of vehicle, e.g. a passenger car or a truck, which can be driven by a human driver or autonomously.

The driving support system 34 comprises in this embodiment a set of environment sensors 36, 38, 40 for monitoring an environment 42 of the traffic participant 14. The environment sensors 38, 40, 42 comprise a LIDAR-based environment sensor 36, an optical camera 38 and multiple ultrasonic sensors 40. The environment sensors 36, 38, 40 generate environment sensor information, which can comprise raw data or pre-processed data.

The traffic participant 14 of the first embodiment further comprises a processing device 44 and a data connection 46, which interconnects the environment sensors 36, 38, 40 and the processing device 44. The processing device 44 can be any kind of processing device 44 suitable for the use in the traffic participant 14. Such processing devices 44 are typically known as ECU (electronic control unit) in the automotive area. The processing device 44 can be shared for performing multiple tasks or applications.

The data connection 46 can be a dedicated connection between the environment sensors 36, 38, 40 and the processing device 44 or a data bus. Furthermore, the data connection 46 can be a shared data connection 46 used by different kinds of devices of the traffic participant 14, e.g. a multi-purpose data bus. The data connection 46 can be implemented e.g. as CAN-bus, LIN-bus, or others.

Although a single data connection 46 is depicted in FIG. 3, multiple connections or data busses can be provided in parallel for connecting the environment sensors 36, 38, 40 to the processing device 44, and which are considered together as data connection 46. The environment sensor information from the environment sensors 36, 38, 40 is transferred to the processing device 44 via the data connection 46. Similarly, although a single processing device 44 is depicted in FIG. 3, multiple processing devices 44 can be provided in parallel.

The traffic participant 14 further comprises a communication device 48 for communication with the intersection blocking prevention unit 16. The communication device 48 is connected via the data connection 46 to the processing device 44 and receives the environment sensor information from the processing device 44. The communication device 48 and the communication unit 22 are provided for communication using a mobile phone network like UMTS, LTE or 5G or using a short rage connection, e.g. Bluetooth or WiFi.

Although the described traffic participant 14 of the first embodiment comprises multiple environment sensors 36, 38, 40, also traffic participants 14 with only some or just one of the environment sensors 36, 38, 40 can form part of the intersection blocking prevention system 10. Further alternative traffic participants 14 can also form part of the intersection blocking prevention system 10, as long as they comprise a communication device 48 for communication with the intersection blocking prevention unit 16. This is indicated by way of example in FIG. 7, where the different traffic participants 14 have different coverage areas 50 depending on their environment sensors 36, 38, 40. One of the traffic participants 14 covers with its coverage area 50 a surround view, one of the traffic participants 14 covers with its coverage area 50 merely a view directly ahead of itself, and a third traffic participant 14 has coverage area 50 limited to itself.

Subsequently will be described a method for performing an intersection blocking prevention for traffic participants 14 in vicinity of the intersection 12. A flow chart of the method is depicted in FIG. 9. The method is performed using the intersection blocking prevention system 10 of FIG. 1. The method is described with additional reference to FIGS. 4, 5 and 7.

The method starts with step S100, which refers to defining the non-blocking area 28 for the intersection 12. The non-blocking area 28 is defined just once for each intersection blocking prevention unit 16 when the intersection blocking prevention unit 16 is installed and/or set up.

Step S110 refers to receiving environment sensor information covering the exiting areas 30, the entrance areas 32 and the non-blocking area 28 of the intersection 12.

The environment sensor information refers to information regarding objects including traffic participants 14 at the intersection 12, i.e. objects in the exiting area 30, in the entrance area 32, and in the non-blocking area 28. The environment sensor information is provided partially from the traffic participants 14 and is gathered using their environment sensors 36, 38, 40. A further part of the environment sensor information is provided from the infrastructure environment sensor 18.

The environment sensor information can comprise processed or unprocessed sensor data. In some cases, the environment sensor information is processed at the traffic participant 14 or the infrastructure environment sensor 18 to reduce an amount of data to be transmitted to the intersection blocking prevention unit 16. In some cases, the environment sensor information merely includes information in respect to other traffic participants 14.

The method can be performed based on any suitable environment sensor information covering the intersection 12 with the at least one exiting area 30, the at least one entrance area 32 and the non-blocking area 28. In an alternative embodiment, no infrastructure environment sensor 18 is installed at the intersection 12, and step S110 is performed merely based on the environment sensor information from the environment sensors 36, 38, 40 of the traffic participants 14. The other way round, in another alternative embodiment, the traffic participants 14 in the vicinity of the intersection 12 are not equipped with environment sensors 36, 38, 40 or they cannot provide environment sensor information from their environment sensors 36, 38, 40 to the intersection blocking prevention unit 16, and step S110 is performed merely based on the environment sensor information from the infrastructure environment sensor 18.

In this embodiment, as indicated e.g. in FIGS. 4 and 5, environment sensor information is received at least from the infrastructure environment sensor 18, indicated by the field of view a and the optical camera 38 of one of the traffic participants 14, indicated by the field of view β.

Step S120 refers to performing fusion of the environment sensor information received from the multiple environment sensors 18, 36, 38, 40. Hence, the environment sensor information all environment sensors 18, 36, 38, 40 is used to obtain a reliable understanding of a traffic situation at the intersection 12. The fusion of the environment sensor information is performed independently from the kind of environment sensor information and the kind of environment sensor 18, 36, 38, 40. Hence, the environment sensor information from the optical cameras 18, 40, the LiDAR-based environment sensor 36 and the ultrasonic sensors 40 is commonly processed. In one embodiment, a 2D-maplike representation of the vicinity of the intersection 12 is provided based on the fusion.

Step S130 refers to determining a free space 52 in the exiting areas 30 as a space between the non-blocking area 28 and a traffic participant 14 located in the respective exiting area 30 closest to the non-blocking area 28.

The free space 52, which is indicated by way of example in FIG. 5, is a space of the exiting area 30, which is not occupied by other traffic participants 14, and which can potentially receive one or more further traffic participants 14 depending on their size. However, when the free space 52 is too small, it cannot receive any further traffic participant 14. The free space 52 depends on further traffic participants 14 located in the exiting area 30 and refers to the space between the non-blocking area 28 and the traffic participant 14 located in the respective exiting area 30 closest to the non-blocking area 28. The free space 52 is in general independent from driving lanes and merely specifies a space for receiving further traffic participants 14. As can be seen in FIG. 5, only one driving lane contributes to the free space 52.

Step S140 refers to receiving infrastructure data from the infrastructure, in particular from the traffic light 20. The traffic light 20 sends its lightening status to the intersection blocking prevention unit 16.

Step S150 refers to receiving traffic participant data from at least some of the traffic participants 14.

The traffic participant data refers to data different to environment sensor information. The traffic participant data is data related to the respective traffic participant 14, i.e. a position of the respective traffic participants 14, its velocity, its driving direction, odometry information, size or an identification of the respective traffic participant 14 as well as status information like emergency conditions or malfunctions, just to name a few.

Step S160 refers to identifying a traffic participant 14 in the at least one entrance area 32 with a driving path 54 to the at least one exiting area 30.

The driving path 54 specifies—beginning from the entrance area 32—at which exiting area 30 the traffic participant 14 will leave the intersection 12 and continue its way. By way of example, the traffic participant 14 approaching from the left side in FIGS. 4 and 5 has its turning indicators switched on and wants to turn left. Hence, a driving path 54 of this traffic participant 14 leads from its current position into the exiting area 30 to its left, i.e. the top of FIGS. 4 and 5.

Step S160 refers to an identification of a possible traffic participant 14 entering and passing through the non-blocking area 28 towards the at least one exiting area 30 along the driving path 54. Hence, this traffic participant 14 can potentially block the intersection 12 in case it does not fit in the free space 52 of the respective exiting area 30.

The traffic participant 14 is identified in the entrance area 32 together with its driving path 54 to the respective exiting area 30 based on the received environment sensor information under consideration of the received traffic participant data received in a respective message and the received infrastructure data. Hence, the identification is performed based on an observation of the traffic participants using the environment sensors 18, 36, 38, 40 together with the information provided from the traffic participants 14 themselves. In the example shown in FIGS. 4 and 5, the respective traffic participant 14 approaching from the left side has turned on the turning indicator light on its left side. Hence, the respective traffic participant 14 wants to turn let at the intersection 12. This is detected by the optical cameras 18, 38 and also indicated in the message sent from the respective traffic participant 14 to the intersection blocking prevention unit 16. The message includes further information like dimensions of the respective traffic participant 14 or others.

Step S170 refers to determining if the identified traffic participant 14 fits the free space 52 in the at least one exiting area 30 according to its driving path 54.

The identified traffic participant 14 fits the free space 52 in the respective exiting area 30 if it can enter the exiting area 30 and does not block the intersection 12, i.e. the traffic participant 14 does not remain in the non-blocking area 28.

The intersection blocking prevention unit 16 determines if the identified traffic participant 14 fits the free space 52 in the respective exiting area 30 according to its driving path 54 based on the received environment sensor information together with the message received from the respective traffic participant 14 specifying its size. Hence, the determination is performed based on an observation of the traffic participants 14 using the environment sensors 18, 36, 38, 40 together with the information provided from the respective traffic participant 14 itself.

In order to determine if the identified traffic participant 14 fits the free space 52 in the respective exiting area 30 according to its driving path 54 comprises determining a size L of the identified traffic participant 14 and a minimum distance d between two traffic participants 14 and comparing the size L of the identified traffic participant 14 and the minimum distance d between two traffic participants 14 to the free space 52. In other words, if the free space has a comprises an area defined by the minimum distance d and an area defined by a remaining length A, the traffic participant 14 fits the free space 52, if the remaining length A is bigger than the size L of the identified traffic participant 14.

The minimum distance d between two traffic participants 14 is used to prevent a physical contact between the traffic participants 14. The minimum distance d can be a fix, preset value based on a required safety distance between the traffic participants 14. In this embodiment, the minimum distance d between two traffic participants 14 is determined by monitoring distances between adjacent traffic participants 14 in the vicinity of the intersection 12 and determining the minimum distance d as average distance between the adjacent traffic participants 14 in that area. The minimum distance d is determined based on an observation of the behavior of the different traffic participants 14 in the vicinity of the intersection 12 using the environment sensors 18, 36, 38, 40 together with known positions of the traffic participants 14 and their dimensions, as transmitted from the respective traffic participants 14 to the intersection blocking prevention unit 16.

The traffic participant 14 fits the free space 52 if the free space 52 is bigger than the size L of the identified traffic participant 14 together with a space defined by the minimum distance d between two traffic participants 14. As can be seen in FIG. 5, a remaining size A of the free space 52 is smaller than the size L of the identified traffic participant 14 approaching from the left, so that the respective traffic participant 14 does not fit the free space 52.

Step S180 refers to sending a warning message to the identified traffic participant 14 in case it does not fit in the free space 52 in the at least one exiting area 30 according to its driving path 54. The warning message is sent from the intersection blocking prevention unit 16 via its communication unit 22 and received at the communication device 48 of the respective traffic participant 14.

The warning message can be any kind of message, which indicates that the non-blocking area 28 will be blocked in case the respective traffic participant 14 advances into the non-blocking area 28. Sending the warning message to the identified traffic participant 14 in case it does not fit in the free space 52 in the respective exiting area 30 according to its driving path 54 comprises sending a warning message for partial intersection blocking in case the identified traffic participant 14 partially fits in the free space 52 in the respective exiting area 30 according to its driving path 54, as can be seen in FIG. 5. However, based on the example shown in FIG. 4, sending the warning message to the identified traffic participant 14 in case it does not fit in the free space 52 in the respective exiting area 30 according to its driving path 54 comprises sending a warning message for full intersection blocking in case the identified traffic participant 14 does not at all fit in the free space 52 in the respective exiting area 30 according to its driving path 54.

Furthermore, a priority vehicle blocking warning message can be sent to the identified traffic participant 14 and/or to priority vehicles in case the respective traffic participant 14 at least partially blocks the non-blocking area 28.

Upon reception at the traffic participant 14, the warning message can generate a warning via a user interface e.g. to human passengers and/or it can be processed by an autonomous driving system of the respective traffic participant 14.

Step S190 refers to determining if the intersection 12 is blocked. This step can be performed independently from some of the previous steps.

When the intersection 12 is blocked, i.e. traffic participants 14 are located in the non-blocking area 28 without moving, no further traffic participants 14 shall enter the intersection 12, in particular the non-blocking area 28.

The step of determining if the intersection 12 is blocked can be performed based on the received environment sensor information and/or based on the received traffic participant data from the traffic participants 14 and/or based on the received infrastructure data. For example, the received environment sensor information can indicate that one or more traffic participant(s) 14 is/are in standstill in the non-blocking area 28, which indicates that the intersection 12 is blocked. Furthermore, at least one of the traffic participants 14 can send a message containing traffic participant data indicating its position and its velocity being zero to the intersection blocking prevention unit 16. In case its current position overlaps with the non-blocking area 28, this indicates that the intersection 12 is blocked.

When the intersection 12 is already blocked, no further traffic participants 14 shall enter the intersection 12, in particular the non-blocking area 28.

Accordingly, in step S200, the intersection blocking prevention unit 16 sends a warning message to the traffic participants 14.

A respective warning message is sent at least to those traffic participants 14, which are about to enter the non-blocking area 28. This refers e.g. to traffic participants 14, which are closest to the non-blocking area 28 in the respective entrance areas 32. Hence, all these traffic participants 14 have been based on their driving path 54.

The above-described method is continuously performed except for step S100.

Furthermore, the described method steps can be performed in different sequences. The above described sequence is merely one example for performing the method. Based on the received information, i.e. the environment sensor information, the traffic participant data and/or the infrastructure data, the different method steps can be performed in any suitable order to obtain any desired information.

Accordingly, FIG. 6 shows a flow chart of a modified embodiment of the above described method according to a second embodiment. The methods of the first and second embodiment are highly similar, so that only differences will be described below in detail.

According to FIG. 6, the method starts with “START”. The non-blocking area 28 is already defined for the intersection 12 according to step S100.

Subsequently, data is received and gathered from the traffic participants 14, the infrastructure environment sensor 18 and the traffic lights 20. This refers to steps S110, S140 and S150 as described above. Furthermore, fusion of the received environment sensor information according to step S120 is performed.

Subsequently an intersection status is determined. This refers to step S130 as described above, in combination with step S190.

Subsequently, a verification is performed to determine if the intersection 12 is blocked. This is also part of step S190 as described above. In case the intersection 12 is blocked, the warning message is sent to all traffic participants 14 which might advance into the non-blocking area 28 based on the traffic light 20 indicating “go”, i.e. green light, in accordance with above step S200, and the method stops.

In case the intersection 12 is not blocked, the intersection blocking prevention unit 16 verifies if the there is enough space for traffic participants 14 in accordance with above step S170. If this is the case, the method stops. Otherwise, the warning message is sent to the respective traffic participants as discussed above with respect to step S180.

Also the method of the second embodiment is performed repeatedly.

FIG. 8 shows a flow chart of a detailed method according to a third embodiment based on the above described method of the first embodiment. The method of the third embodiment comprises an additional feature related to priority vehicles.

According to FIG. 8, the method starts with “START”. The non-blocking area 28 has already been defined for the intersection 12 according to step S100.

Furthermore, data has been received and gathered from the traffic participants 14, the infrastructure environment sensor 18 and the traffic lights 20. This refers to steps S110, S140 and S150 as described above. Furthermore, fusion of the received environment sensor information according to step S120 has been performed.

Based on the received information, the intersection blocking prevention unit 16 determines if a priority vehicle is incoming. In this case, a respective priority vehicle message is sent.

Otherwise, the method continues with loading the infrastructure information. This comprises loading the definition of the non-blocking are 28 as define din step S100.

Subsequently an intersection status is determined. This refers to step S130 as described above. In detail, the minimum distance d is determined based on the average distance between traffic participants 14 in the exiting area 30, a closest traffic participant 14 to the non-blocking area 28 in the exiting area 30 is determined, and the free space 52 is determined as space between the closest traffic participant 14 and the non-blocking are 28.

Further, in accordance with above steps S160 and S170, if the free space 52 is sufficiently large to receive the traffic participant 14 identified with its driving path 54 to the respective exiting area 30, the method stops. Otherwise, above step S180 is performed. Accordingly, first a verification is performed if the identified traffic participant 14 partially fits in the free space 52 in the respective exiting area 30 according to its driving path 54, as can be seen in FIG. 5, or if the identified traffic participant 14 does not at all fit in the free space 52 in the respective exiting area 30 according to its driving path 54, so that a full intersection blocking will occur. In each case, a respective message is sent form the intersection blocking prevention unit 16 to the respective traffic participant 14.

Also the method of the third embodiment is performed repeatedly.

### REFERENCE SIGNS LIST

10 intersection blocking prevention system
12 intersection
14 traffic participant, vehicle
16 intersection blocking prevention unit
18 infrastructure environment sensor
20 traffic light
22 communication unit
24 processing unit
26 street
28 non-blocking area
30 exiting area
32 entrance area
34 driving support system
36 LiDAR-based environment sensor, environment sensor
38 optical camera, environment sensor
40 ultrasonic sensor, environment sensor
42 environment
44 processing device
46 data connection
48 communication device
50 coverage area
52 free space
54 driving path
d minimum distance
A remaining length
L size of the identified traffic participant

1. A method for performing an intersection blocking prevention for traffic participants in vicinity of the intersection, the method comprising:
defining a non-blocking area for the intersection;
receiving environment sensor information covering at least one exiting area and at least one entrance area adjacent to the non-blocking area and connected to the intersection;
determining a free space in the at least one exiting area as a space between the non-blocking area and a traffic participant located in the respective exiting area closest to the non-blocking area;
identifying a traffic participant in the at least one entrance area with a driving path to the at least one exiting area;
determining if the identified traffic participant fits the free space in the at least one exiting area according to its driving path; and
sending a warning message to the identified traffic participant in case it does not fit in the free space in the at least one exiting area according to its driving path.

2. The method according to claim 1, wherein
receiving environment sensor information covering at least one exiting area and at least one entrance area adjacent to the non-blocking area and connected to the intersection comprises receiving environment sensor information from at least one environment sensor of at least one traffic participant or at least one environment sensor installed at the intersection.

3. The method according to claim 1,
wherein the receiving environment sensor information comprises receiving environment sensor information from multiple environment sensors, and
wherein the method further comprises performing fusion of the environment sensor information received from the multiple environment sensors.

4. The method according to claim 1,
wherein identifying a traffic participant in the at least one entrance area with a driving path to the at least one exiting area comprises:
identifying the traffic participant in the at least one entrance area and its driving path to the at least one exiting area based on the received environment sensor information, or
identifying the traffic participant in the at least one entrance area and its driving path to the at least one exiting area based on a message received from the respective traffic participant identifying itself, its position, and its driving path.

5. The method according to claim 1,
wherein determining if the identified traffic participant fits the free space in the at least one exiting area according to its driving path comprises:
determining if the identified traffic participant fits the free space in the at least one exiting area according to its driving path based on the received environment sensor information, or
determining if the identified traffic participant fits the free space in the at least one exiting area according to its driving path based on a message received from the respective traffic participant specifying its size.

6. The method according to claim 1,
wherein determining if the identified traffic participant fits the free space in the at least one exiting area according to its driving path comprises determining a size of the identified traffic participant and a minimum distance between two traffic participants and comparing the size of the identified traffic participant and the minimum distance between two traffic participants to the free space.

7. The method according to claim 6,
wherein determining a minimum distance between two traffic participants comprises monitoring distances between adjacent traffic participants in the vicinity of the intersection and determining the minimum distance as average distance between the adjacent traffic participants in the vicinity of the intersection.

8. The method according to claim 1
wherein sending a warning message to the identified traffic participant in case it does not fit in the free space in the at least one exiting area according to its driving path comprises sending:
a warning message for partial intersection blocking in case the identified traffic participant partially fits in the free space in the at least one exiting area according to its driving path,
a warning message for full intersection blocking in case the identified traffic participant does not at all fit in the free space in the at least one exiting area according to its driving path, or
a priority vehicle blocking warning message to the identified traffic participant or to the priority vehicle in case at least one traffic participant at least partially blocks the non-blocking area.

9. The method according to claim 1
wherein the method further comprises receiving traffic participant data from at least one of the traffic participants, and
wherein identifying a traffic participant in the at least one entrance area with a driving path to the at least one exiting area comprises identifying the traffic participant under consideration of the received traffic participant data.

10. The method according to claim 1
wherein the method further comprises receiving infrastructure data from the infrastructure, in particular a traffic light, and
wherein identifying a traffic participant in the at least one entrance area with a driving path to the at least one exiting area comprises identifying the traffic participant under consideration of the received infrastructure data.

11. The method according to claim 1 further comprising:
determining if the intersection is blocked; and
sending a warning message to the traffic participants.

12. An intersection blocking prevention unit for preventing blocking the intersection with traffic participants in vicinity of the intersection,
wherein the intersection blocking prevention unit is configured to perform the method of claim 1 any.

13. An intersection blocking prevention system for preventing blocking the intersection with traffic participants in vicinity of the intersection, comprising: the intersection blocking prevention unit of claim 12; and multiple traffic participants in communication connection with the intersection blocking prevention unit.
